(19) United States
(12) Patent Application Publication
(10) Pub. No.: US 2025/0356375 A1
(43) Pub. Date: Nov. 20, 2025

(54) SYSTEMS AND METHODS FOR USING FEATURE COMPUTATION SYSTEMS TO JOIN EVENT STREAMS

(71) Applicant: Stripe, Inc., South San Francisco, CA (US)

(72) Inventors: Jonathon Daniel BROWN, South San Francisco, CA (US); Massoud HOSSEINALI, South San Francisco, CA (US); Nadha GAFOOR, South San Francisco, CA (US)

(21) Appl. No.: 18/665,190

(22) Filed: May 15, 2024

(51) Int. Cl. G06Q 30/018; G06F 9/54

(52) U.S. Cl. CPC G06Q 30/0185; G06F 9/542

(57) ABSTRACT

One method includes detecting a condition associated with an event stream of a first plurality of event streams associated with a first system; determining that the event stream is associated with a second system; identifying a second plurality of event streams associated with the second system; generating, based on the condition, an event data structure comprising a first set of events identified from the first plurality of event streams and a second set of events identified from the second plurality of event streams; converting the event data structure into at least two feature vectors corresponding to the first system and the second system for one or more machine-learning models; and executing the one or more machine-learning models using the at least two feature vectors as input and outputting a likelihood of fraud for the first system or the second system.

### TECHNICAL FIELD

This application relates generally to generating data structures for training and executing artificial intelligence models.

### BACKGROUND

Advanced machine-learning systems, particularly systems that process large volumes of real-time or near-real-time electronic information, are often constrained by memory or network bandwidth. This is due to the large volume of information used to generate input data structures for machine-learning models to generate desired outputs. Non-limiting examples of machine-learning models may include models for detecting fraudulent transactions or transfers.

However, the memory access requirements to execute these models, particularly for real-time or near real-time fraud detection and monitoring, introduces several technical challenges. Most approaches for generating input for advanced machine-learning models require complex and time-consuming feature retrieval processes, relying on offline or asynchronous feature generation techniques to provide input data for feature processing. Conventional techniques cannot produce satisfactory results because they cannot produce and provide input data for such machine-learning models without exhausting memory resources or bandwidth.

### SUMMARY

For the aforementioned reasons, there is a desire for methods and systems to rapidly and efficiently generate input data, such as input feature vectors, for machine-learning operations to generate indications of fraud or to perform training of machine-learning models. As used herein, feature vectors may include any type of vector or data structure that includes information that may be provided as input to a machine-learning model.

Using the systems and methods described herein, one or more processors (e.g., an analytics server or cloud computing environment) can execute a feature generation system to join events from multiple event streams determined to be related to a condition of an external system. The condition may be, in one example, a transaction, a payment, an instance of non-payment, a chargeback, or any other type of event that may be provided via an event stream. The systems and methods described herein can use feature generation techniques to generate a joined event data structure, which is then provided to a feature generation system to generate a feature vector for input to a machine-learning model.

Because these techniques do not rely on conventional approaches for generating event data, the approaches described herein do not suffer from the memory and bandwidth constraints of conventional systems. Using the systems and methods described herein, input feature vectors can be efficiently generated and provided for machine-learning inference or training by joining recent events from both event streams and event archives. Joining events from event streams in this manner does not require computationally costly upstream event joining operations and is, therefore, more efficient with regard to time and computing resources.

The event joining and feature generation approaches described herein can also join events from multiple systems/platforms, which may be associated based on their respective events and configuration settings. As a result, input feature vectors can be generated for multiple systems/platforms in response to a single trigger event, in some implementations, enabling automatic detection of fraud or other properties of secondary systems/platforms based on trigger events that occur in connection with primary systems.

In an embodiment, a method comprises detecting a condition associated with an event stream of a first plurality of event streams associated with a first system; determining, by the one or more processors, that the event stream is associated with a second system; identifying, by the one or more processors, a second plurality of event streams associated with the second system; generating, by the one or more processors, based on the condition, an event data structure comprising a first set of events identified from the first plurality of event streams and a second set of events identified from the second plurality of event streams; converting, by the one or more processors, the event data structure into at least two feature vectors corresponding to the first system and the second system for one or more machine-learning models; and executing, by the one or more processors, the one or more machine-learning models using the at least two feature vectors as input and outputting a likelihood of fraud for the first system or the second system.

In another embodiment, a system comprises one or more processors coupled to non-transitory memory. The one or more processors are configured to detect a condition associated with an event stream of a first plurality of event streams associated with a first system; determine that the event stream is associated with a second system; identify a second plurality of event streams associated with the second system; generate, based on the condition, an event data structure comprising a first set of events identified from the first plurality of event streams and a second set of events identified from the second plurality of event streams; convert the event data structure into at least two feature vectors corresponding to the first system and the second system for one or more machine-learning models; and execute the one or more machine-learning models using the at least two feature vectors as input and outputting a likelihood of fraud for the first system or the second system.

### BRIEF DESCRIPTION OF THE DRAWINGS

Non-limiting embodiments of the present disclosure are described by way of example with reference to the accompanying figures, which are schematic and are not drawn to scale. Unless indicated as representing the background art, the figures represent aspects of the disclosure.

FIG. 1 illustrates various components of an example event joining and feature generation system for machine-learning operations, according to an embodiment.

FIGS. 2A and 2B illustrate dataflow diagrams showing how an event joining system and feature generation system generates feature vectors in response to trigger conditions of event streams, according to an embodiment.

FIG. 3 illustrates a flow diagram of a process executed in an event joining and feature generation system, according to an embodiment.

FIG. 4 illustrates a component diagram of a computing system suitable for use in the various implementations described herein, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein—and additional applications of the principles of the subject matter illustrated herein—that would occur to one skilled in the relevant art and having possession of this disclosure are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

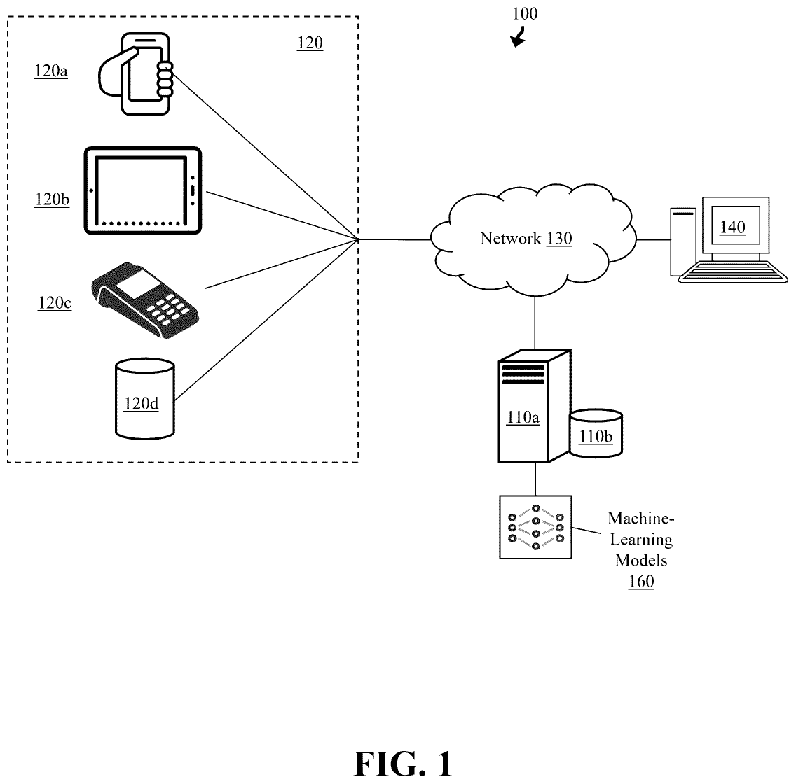

FIG. 1 is a non-limiting example of components of an example event joining and feature generation system 100 in which an analytics server 110a operates. The analytics server 110a may utilize features described in FIG. 1 to retrieve and analyze data and generate/display results. However, the system 100 is not confined to the components described herein and may include additional or other components not shown for brevity, which are to be considered within the scope of the embodiments described herein.

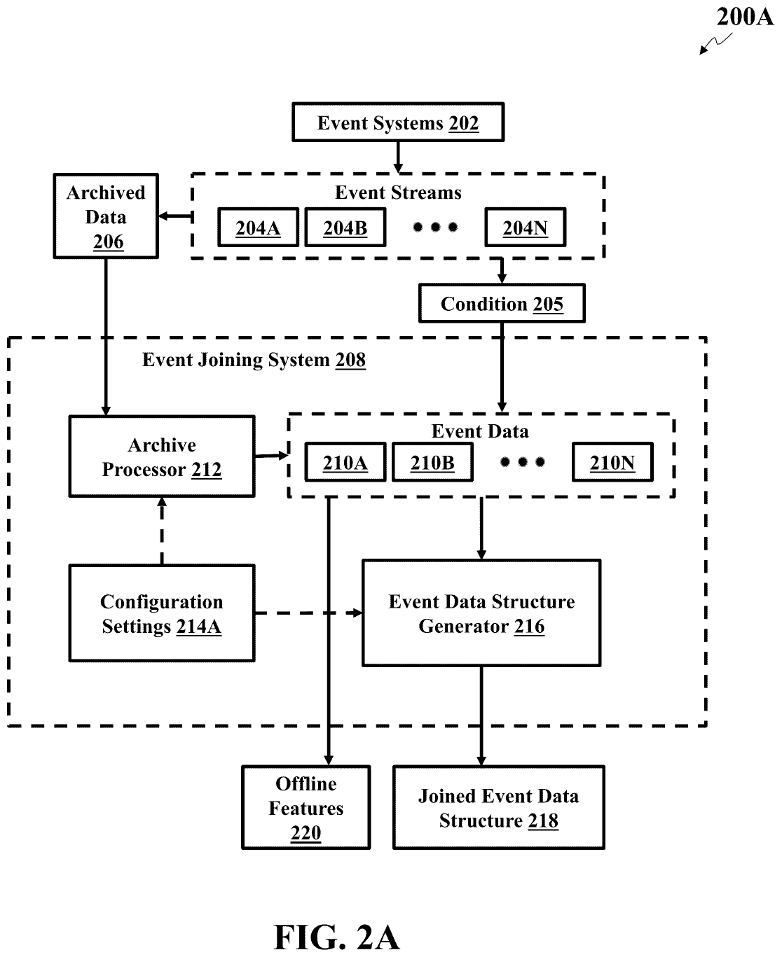

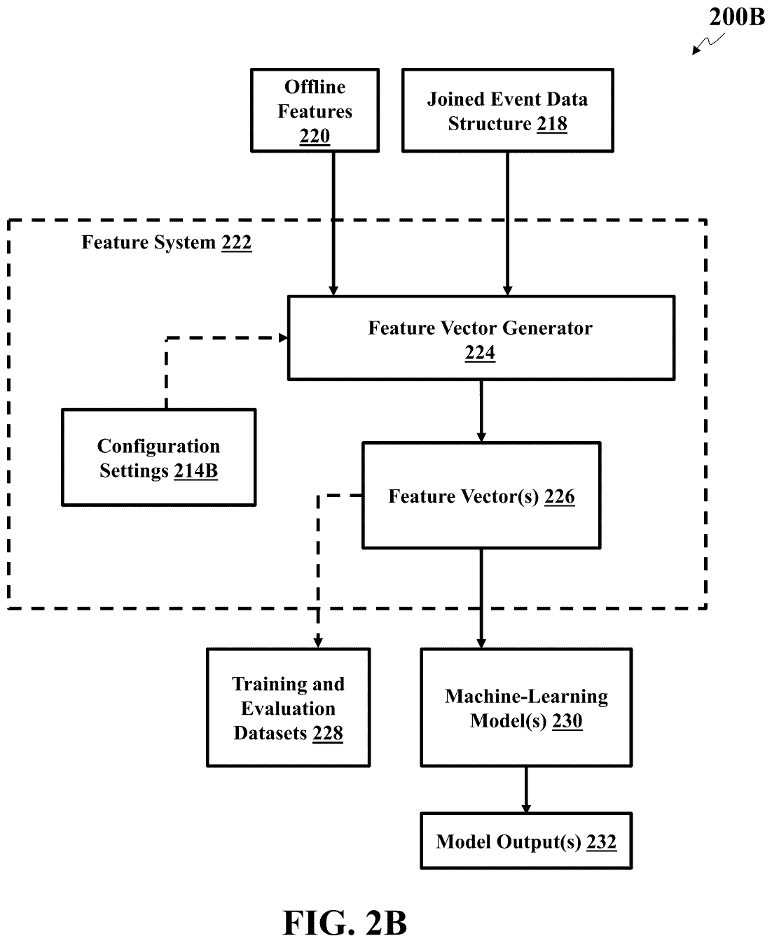

The analytics server 110a may be communicatively coupled to a system database 110b, an electronic payment system 120 (including electronic devices 120a-120e), and an administrator computing device 140. The analytics server 110a may also use various computer models (e.g., one or more machine-learning models 160) to analyze the data retrieved from the electronic payment system 120. The analytics server 110a may execute or otherwise implement any of the operations described in connection with FIGS. 2A and 2B, for example, to generate joined event data structures and feature vectors for input to one or more machine-learning models 160.

The above-mentioned components may be connected through a network 130. The examples of the network 130 may include, but are not limited to, private or public LAN, WLAN, MAN, WAN, and the Internet. The network 130 may include both wired and wireless communications according to one or more standards and/or via one or more transport mediums.

Communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, e.g., a GSM (Global System for Mobile Communications), CDMA (Code Division Multiple Access), and/or EDGE (Enhanced Data for Global Evolution) network.

The analytics server 110a may generate and display an electronic platform configured to output the results of analyzing data retrieved, generated, or otherwise processed according to the techniques described herein. The electronic platform may include one or more graphical user interfaces (GUIs) displayed on the administrator computing device 140. An example of platforms generated and hosted by the analytics server 110a may include a web-based application or a website configured to be displayed on various electronic devices, such as mobile devices, tablets, personal computers, and the like. In a non-limiting example, the platform may be used to identify possible fraudulent activity and/or system failures associated with the electronic payment system 120. For instance, the platform may indicate that one or more elements of transaction processing might be having technical issues. The platform may also indicate one or more attributes associated with the technical issue, e.g., the transaction server in Mexico is down.

The analytics server 110a may be any computing device comprising one or more processors and non-transitory, machine-readable storage capable of executing the various tasks and processes described herein. The analytics server 110a may employ various processors, such as a central processing unit (CPU) and graphics processing unit (GPU), among others. Non-limiting examples of such computing devices may include workstation computers, laptop computers, server computers, and the like. While the system 100 is shown as including a single analytics server 110a, the analytics server 110a may include any number of computing devices operating in a distributed computing environment, such as a cloud environment.

The electronic payment system 120 may represent various electronic components that receive, retrieve, and/or access data needed to perform one or more transactions and facilitate payments. Therefore, the electronic payment system 120 may include various hardware and software components. For instance, the electronic payment system 120 may include an end-user device 120a executing a payment application (hosted by a payment server 120d). An end-user (e.g., merchant) may use the payment application to send/receive payments to other users or other recipients inside/outside a payment network.

In another example, a merchant device 120b may execute the payment application (hosted by the payment server 120d) to facilitate transactions and generate transaction documents and receipts. In another example, a merchant may use a point-of-sale system 120c to facilitate one or more transactions (e.g., card-present transactions). In a non-limiting example, the electronic payment system 120 may represent a payment application hosted by one or more servers (e.g., payment server 120d) that facilitates electronic payments between different devices. The payment system 120 may monitor and detect any type of event relating to transactions, including chargeback events, declined transactions, incorrect information provided for a transaction, timestamps, or other transaction-related information.

In some embodiments, the data received from different components of the electronic payment system 120 may be transmitted (e.g., by the payment server 120d) to the analytics server 110a to be analyzed. The analytics server 110a may then apply various analytical protocols discussed herein to analyze the data and present the results for a system administrator operating the administrator computing device 140. For example, the analytics server 110a can generate joined event data structures, feature vectors, and execute one or more machine-learning models 160 to generate indications of fraud or other metrics associated with the payment system 120. Although one payment system 120 is indicated in this arrangement, it should be understood that any number of payment systems 120 may be present in the system 100. In some implementations, a payment system may include any number of end-user devices 120a, merchant devices 120b, point-of-sale systems 120c, or payment servers 120d, in some implementations.

The administrator computing device 140 may represent a computing device operated by a system administrator. The administrator computing device 140 may be configured to display attributes generated by the analytics server 110a (e.g., joined event data structures feature vector(s) generated for one or more the electronic payment systems 120 or components thereof, data generated during training/execution of the machine-learning models 160, etc.); monitor the machine-learning models 160 utilized by the analytics server 110a, review feedback; and/or facilitate training or retraining (calibration) of the machine-learning models 160 that are maintained by or accessed by (e.g., via one or more APIs, etc.) the analytics server 110a.

In a non-limiting example, an administrator may access the platform hosted by the analytics server 110a to monitor the detection of trigger events associated with one or more payment systems 120, access joined event data structures generated based on detected trigger events, access feature vectors generated from joined event data structures, and facilitate execution, training, or monitor outputs of one or more machine-learning models 160. In some implementations, upon the outputs of one or more machine-learning models 160 indicating fraud or other conditions, the analytics server 110a can generate one or more alerts associated with one or more payment systems 120.

The platform provided by the analytics server 110a can provide the alerts generated by the analytics server 110a. The alerts may identify one or more anomalous behaviors associated with the electronic payment system 120, such as potentially fraudulent events, or other properties of the electronic payment system 120 (or the components/systems thereof) generated by the machine-learning models 160. The administrator may review the alerts and indicate whether they are true positive alerts or false positive alerts, which may indicate incidences or likelihoods of fraud at the electronic payment system 120, a merchant device 120b, a point-of-sale system 120c, or other systems/devices of the electronic payment system 120. The analytics server 110a may monitor the administrator's activity and interactions with the alerts. The administrator may initiate or coordinate training or updating of one or more machine-learning models 160 via input. In some implementations, the administrator may update training data, such as the training and evaluation datasets 228 described in connection with FIG. 2B, to include labels or indications of ground-truth data.

The machine-learning models 160 may be trained using data received or retrieved from the analytics server 110a and/or the electronic payment system 120. The analytics server 110a may execute one or more of the machine-learning models 160 by providing one or more feature vectors (e.g., the feature vectors 226 of FIG. 2B generated according to the techniques described herein) to identify indications of fraud or indications of other predicted conditions of merchant systems or platforms. Additionally, the analytics server 110a may train the machine-learning model 160 using a training dataset (e.g., the training and evaluation datasets 228) generated based on monitoring events and feature vectors associated with one or more electronic payment systems 120. As depicted, the analytics server 110a may store the machine-learning models 160 (e.g., neural networks, random forest, support vector machines, regression models, recurrent models, etc.) in an accessible data repository, such as the system database 110b.

In some implementations, the analytics server 110a may utilize one or more application programming interfaces (APIs) to communicate with one or more of the electronic devices described herein. For instance, the analytics server may utilize APIs to automatically transmit/receive data to/from the machine-learning models 160. Similar APIs may be utilized to initiate, perform, coordinate, and monitor training/re-training/updating of the machine-learning models 160.

The machine-learning models 160 may be trained using various training techniques, including, unsupervised training, semi-supervised training, supervised training, or variants thereof (e.g., self-supervised training, etc.). In an example process to train a machine-learning model 160 using supervised learning, the analytics server 110a can provide one or more training examples (e.g., input data including feature vectors generated according to the techniques described herein) to the machine-learning model 160. The analytics server 110a can execute the machine-learning model 160 to generate a predicted output, which can be compared to ground truth data of the training example(s) using a loss function. The loss function can generate a loss for the machine-learning model 160 and the training example(s), which can be used to update the trainable parameters of the machine-learning model 160 using a suitable optimization algorithm (e.g., via gradient descent, Adam, backpropagation, etc.).

The machine-learning models 160 can represent any type of predictive model that can generate outputs associated with one or more electronic payment systems 120. In some implementations, the machine-learning model 160 can include one or more fraud-detection models. Fraud-detection models may can include one or more computer models that use algorithmic and/or artificial intelligence modeling techniques to verify data associated with different transactions or events of one or more electronic payment systems 120. In some embodiments, different fraud-detection models may be configured to identify fraud using different methods and/or may be trained differently. For example, the machine-learning models 160 may be a collection of different models with different operational parameters.

In some embodiments, a group of the machine-learning models 160 may belong to the same model. That is, in some embodiments, a single model may include various sub-models. Segmenting a single machine-learning model into different sub-models can be a powerful approach to tackle complex tasks, such as detecting potentially fraudulent transactions or predicting attributes associated with different events of an electronic payment system 120.

FIGS. 2A and 2B illustrate dataflow diagram 200A and 200B, respectively, showing how an event joining system 208 and feature system 222 generate feature vectors 226 in response to trigger conditions 205 of event streams 204A-204N, according to an embodiment. FIG. 2A shows an event joining system 208, which may be implemented in hardware, software, or combinations of hardware and software, for example, by the analytics server 110a of FIG. 1. The event joining system 208 can monitor data from one or more event streams 204A-204N (sometimes referred to as “event stream(s) 204”).

Event streams 204 are shown as being updated by event systems 202. The event systems 202 can be any type of device, platform, or system that interacts with, or is included in, one or more electronic payment systems (e.g., one or more electronic payment systems 120 of FIG. 1). The event systems 202 can generate event data 210A-210N (sometimes referred to as “events 210A-210A” or “event(s) 210”) in response to different actions or changes. For example, an event 210 can be generated to represent a transaction, a payment, or any other electronic change or interaction at the corresponding event system 202. Other example events 210 can include, but are not limited to, a chargeback detected from a communication from a financial institution, a change in payment or account information, or a change in other electronic information associated with a transaction or payment system.

The event stream(s) 204 can be any type of log or data storage repository that can be updated by one or more event systems 202. Each event stream 204 can be associated with a respective event category, and can be identified by a payment system identifier, a timestamp indicating a time of the latest update (e.g., latest event 210, etc.), or an event topic key value, among other identifiers. Event systems 202 can, upon detecting a change, action, or interaction, can generate a corresponding event 210 that is stored as part of a corresponding event stream 204. The event systems 202 can identify which event stream 204 to store a given event 210 based on the type of the change, interaction, or action associated with the event 210, as well as the payment system/platform associated with the event 210.

In some implementations, the event systems 202 can store information associated with a stored event as part of the event stream 204. For example, the event 210 can store information relating to the type of action, interaction, or change, as well as an identifier of the corresponding payment system associated with the event 210. In an example where the event 210 indicates a transaction, the event 210 can store an identifier of the payment system (e.g., end-user device 120a, merchant device 120b, point-of-sale system 120c, payment server 120d, etc.) corresponding to the transaction, as well as various attributes of the transaction, such as transaction amount, transaction location, and transaction time, among others.

Various events 210 can be stored as part of one or more event streams 204, such as events 210 indicating chargebacks from financial institutions, events 210 indicating changes to address or account information at an account/profile of a payment system (e.g., a payment system 120) or event system 202, indications of changes in the status of an order (e.g., ready to ship, shipped, out for delivery, delivered, etc.), indications of changes in payment method or payment information for a transaction, or indications of changes in a subscription or recurrent payments, among others. The events 210 stored in the event streams 204 can be accessed by the event joining system 208 to generate a joined event data structure 218, as shown.

Events 210 stored in event streams 204 may be archived as part of the archive data 206 in response at least one archive condition being satisfied. In one example, events 210 in an event stream 204 can be archived when a time period since the generation of said events 210 has been exceeded (e.g., one week, one month, three months, etc.). Any suitable condition can be applied to the event streams 204 to store events 210 in the archive data 206. Events 210 in different event streams 204 may be archived (e.g., stored in a database, such as a relational database, etc.) according to different archive conditions or rules, in some implementations.

The event joining system 208 may be implemented, in one example, by the analytics server 110a of FIG. 1 or by one or more computing systems in communication with the analytics server 110a of FIG. 1. The event joining system 208 (or components thereof, as described herein) can monitor the event streams 204 for updated events 210 generated by the event systems 204. If a trigger condition 205 is detected (e.g., an event in an event stream 204 satisfies predetermined or dynamically determined criteria, etc.), the event joining system 208 can initiate a process to generate a joined event data structure 218 (and, in some implementations, one or more offline features 220, etc.).

The trigger condition 205 can be associated with a given event stream 204 of an identified merchant, system, or platform. In some implementations, trigger conditions 205 for different payment systems/platforms can be stored as part of configuration settings 214A. The configuration settings 214A can be any set of configuration instructions or data used by the event joining system 208 to generate the joined event data structures 218 described herein. The configuration settings 214A may be provided or otherwise specified by an administrator (e.g., via an administrator computing device 140 of FIG. 1, etc.).

The event joining system 208 can, upon detecting a change (e.g., an update) to an event stream 204, can compare said update (e.g., a new event 210, etc.) or data relating to said event stream 204 to the trigger condition 205. One example of trigger condition 205 is if a transaction is conducted via a particular merchant, platform, or system. Another example of condition 205 is detecting an event 210 added to an event stream 204 that represents a chargeback. Other example trigger conditions 205 can include a transaction amount exceeding or falling below a predetermined (or dynamically determined) amount, a transaction location satisfying predetermined criteria, or a predetermined number of transactions being exceeded within a time period, among others.

If a trigger condition 205 has been detected in an event stream 204 associated with a merchant/platform/system, the event joining system 208 can execute the event data structure generator 216, which can identify a set of event streams 204 associated with said merchant/platform. Identifying the set of event streams 204 can include identifying event streams 204 corresponding to the trigger condition 205. For example, if the trigger event is a transaction involving a particular merchant location, the event data structure generator 216 can identify other event streams 204 corresponding to that merchant location. In some implementations, the configuration settings 214A can specify which event streams 204 (or event categories) can be associated with a particular trigger condition 205. When a trigger condition 205 is satisfied, the event data structure generator 216 can access the event streams 204 associated with the trigger condition 205.

Upon identifying the event streams 204, the event data structure generator 216 can retrieve a set of events from the event streams 204. In some implementations, retrieving the set of events 210 can include filtering events 210 stored at the event streams 204. The filter can include static filtering or dynamic filtering. Static filter can include filtering based on static rules, which may be defined as part of the configuration settings 214A. The static filtering can include filtering based on static rules, for example, retrieving a predetermined number of most recent events 210 from an event stream 204, retrieving only certain type(s) of events 210 from an event stream 204, or other filtering criteria. Dynamic filtering operations can be filtering operations that are a function of different attributes of the event stream(s) 204, event(s) 210, or the merchant/platforms associated with said event stream(s) 204 and event(s) 210.

The event data structure generator 216 can access other event streams 204 associated with the trigger condition 205 by accessing one or more secondary keys associated with the trigger condition 205 in the configuration data 205. The secondary key can identify, for example, a partition of the one or more event streams 204 from which at least one of the set of events 210 are to be retrieved. For example, the key may identify the merchant/platform/system, the event type, or another party associated with the respective transaction or trigger condition 205. In some implementations, the keys used to access events 210 of event streams 204 associated with the trigger condition 205 can be determined based on the attributes of the merchant and settings specified in the configuration settings 214A. The keys can identify a merchant location, a merchant device, a user device, a point-of-sale system, transactions, actions, or interactions that occur during a given time period, or other categories of events 210.

In some implementations, the configuration settings 214A can indicate that archived data associated with the merchant/platform is to be included in the joined event data structure 218. To access archived information, the event joining system 208 can execute the archive processor 212, which can access previously provided events stored as part of the archived data 206. As the archived data may include a different data format than the events 210, the archive processor 212 can retrieve (e.g., via one or more communication APIs, etc.) archive data 206 associated with the merchant/platform/system (e.g., as indicated in the configuration settings 214A), and convert said data into an event format. Converting the data can include reformatting the retrieved portions of the archive data 206 to include identifier and/or creation timestamp fields in a format that matches the format of the events 210. Other data conversion techniques may also be implemented, including filtering unused metadata, among others.

In some implementations, the event data structure generator 216 can determine that a secondary system (sometimes referred to herein as “platform”) is associated with the merchant/system/platform associated with trigger condition 205. For example, the secondary system can be a parent entity that is associated with the merchant/system/platform associated with trigger condition 205 (e.g., a child entity). One example configuration is a contractor that operates on behalf of a parent entity/merchant. In this example, the contractor may incur or otherwise be associated with the charge, causing the trigger condition 205 to be satisfied. Upon the trigger condition 205 being satisfied, the event data structure generator 216 can determine that a secondary platform/merchant/system is a parent entity with respect to the contractor (e.g., the parent entity hired the contractor, etc.).

In such implementations, the event data structure generator 216 can access the configuration settings 214A to identify which event streams 204 of the secondary platform/system to access. As described herein, the event data structure generator 216 can perform various filtering techniques to retrieve a second set of events 210 associated with the secondary platform/system. The second set of events 210 can include events, attributes, or other data related to the second platform/system. The particular events 210 and/or event streams 204 of the second platform can be retrieved, in some implementations, based on the trigger condition 205. For example, if a large transaction occurs at one or more contractor systems, the event data structure generator 216 can retrieve other recent transaction events 210 from event streams 204 associated with the parent entity/platform/system. Said events 210 may correspond to a similar location and/or time period as the large transaction in some implementations. Other criteria for selecting event streams 204 and/or types or categories of events 210 associated with a secondary system/platform can be defined in the configuration settings 214A.

Once at least one set of events 210 has been retrieved, the event data structure generator 216 can generate the joined event data structure 218. Generating the joined event data structure 218 can include extracting information from the retrieved set of events 210 and generating a data structure identified, including said data using an identifier of the merchant/system/platform associated with the trigger condition 205. The joined event data structure 218 can, in some implementations, be formatted as a list of values extracted from each of the set of events 210 that are keyed to an identifier of the respective system/platform associated with the trigger condition 205.

When multiple merchants/platforms/systems have been identified (e.g., in a parent/child relationship, as described herein), the event data structure generator 216 can generate a joined event data structure 218 that includes data extracted from the first set of events 210 (e.g., the events of the child system) and data extracted from the second set of events 210 (e.g., the events of the parent system). In some implementations, the joined event data structure 218 can be formatted to include additional identifiers, which may identify portions of the joined event data structure 218 as corresponding to a parent system/platform or a child system/platform. In some implementations, the event data structure generator 216 can generate multiple joined event data structures 218, with one joined event data structure 218 corresponding to and including event data of a parent platform and another joined event data structure 218 corresponding to and including event data of a child platform. In such implementations, each joined event data structure 218 can identify itself as a parent/child platform and may include an identifier of parent/child to which it is associated.

In some implementations, the joined event data structure 218 may be a vector or a row-based data structure with a single row, with each column in the joined event data structure 218 storing data extracted from a respective event 210 and/or event stream 204. The joined event data structure 218 can be, in some implementations, structured to correspond to a feature generation system (e.g., the feature system 222). The joined event data structure 218 can, in some implementations, include data identifying one or more features that are to be generated using the extracted event data. Such metadata may be selected and/or determined based on the trigger condition 205 that caused generation of the joined event data structure 218. The metadata can, in some implementations, specify which machine-learning models (e.g., machine-learning models 160) that are to be executed using the respective event data.

In some implementations, in addition to generating one or more event data structures, additional archived feature data, shown as offline features 220, can be generated by accessing the archived data 206. In one example, the archive processor 212 can retrieve archived feature information, which may include any of the features previously generated for the corresponding merchant/system/platform, to provide as output in conjunction with the joined event data structure 218. The archive processor 212 can convert the archived feature data retrieved from the archived data 206 to a format that is compatible with the feature system 222 of FIG. 2B or other feature generation process.

As shown, the event joining system 208 can provide the joined event data structure(s) 218 and any generated offline features 220 as output. The joined event data structure(s) 218 and offline features 220 can be provided as input to a feature system 222 to generate features. It should be appreciated that the trigger conditions 205 for events 210 in the event streams 204 described herein can be activated upon detecting any type of event 210. In some implementations, this may include generating joined event data structures 218 for each transaction, transfer, action, or interaction at a merchant/platform/system. Filtering criteria specified in the configuration settings 214A can reduce the number of joined event data structures 218 generated for systems that produce large numbers of events 210. Likewise, dynamic filtering rules can be specified in the configuration settings 214A that compensate for sudden changes in the volume of generated events 210. Filtering events 210 may include the foregoing generation of a joined event data structure 218 for certain trigger conditions 205 in some implementations. Further details of a feature generation process are described in connection with FIG. 2B.

FIG. 2B shows a feature system 222, which may be implemented in hardware, software, or combinations of hardware and software, for example, by the analytics server 110a of FIG. 1. The feature system 222 can receive the joined event data structure(s) 218 (and offline features 220, if any) generated by the event joining system 208 of FIG. 2A and generate one or more feature vector(s) 226. As shown, the feature vector(s) 226 can be provided as input to one or more machine-learning models 230 (which may include any of the structure and/or functionality of the machine-learning models 160 of FIG. 1). In some implementations, the feature vectors 226 may be included in one or more training and evaluation datasets 228, which may be used to train/update the machine-learning model(s) 230 or other artificial intelligence models.

Upon receiving a joined event data structure 218 (and any generated offline features 220 associated therewith), the feature system 222 can execute the feature vector generator 224. The feature vector generator 224 can generate the feature vector(s) 226 by accessing the event data stored in the joined event data structure 218. As used herein, a “feature vector” may refer to any type of data structure that is compatible with an input of the machine-learning models 230. For example, a feature vector 226 may include one or more matrices, tensors, or other types of input data structures that may be provided as input to a machine-learning model 230.

The feature vector generator 224 can generate the feature vector 226 by pre-processing the data in the joined event data structure. Pre-processing the data may include performing aggregation processes (e.g., aggregating data to calculate averages or trends of transaction amounts, time periods, or other transaction attributes), normalization processes (e.g., using a suitable normalization algorithm), or data conversion techniques to convert data in different formats to a numerical format compatible with the machine-learning models 230. The features generated using the feature vector generator 224 can each be stored in one or more coordinates or portions of the feature vector 226. The feature vector generator 224 can implement any feature-suitable feature generation algorithm to generate the features of a feature vector 226.

In some implementations, the feature vector generator 224 can identify features to generate based on an indication of the trigger condition 205 that initiated feature vector generation, which may be stored as part of the joined event data structure 218. As shown, the feature system 222 can store its own set of configuration settings 214B, which may include any configurable instructions, values, or data used to coordinate the feature generation process and/or execution/training of the machine-learning models 230. As described herein, the configuration settings 214B can be created, modified, or otherwise updated by an administrator via an administrator computing device (e.g., the administrator computing device 140 of FIG. 1, etc.).

In some implementations, the feature vector generator 224 can generate one or more feature vectors 226 to include one or more of the offline features 220 generated with the joined event data structure 218, as described in connection with FIG. 2A. The offline features 220 may, in some implementations, be updated using up-to-date information in the event data stored in the joined event data structure 218. For example, an average amount per transaction at a merchant/system/platform may be previously stored as an offline feature 220 and provided to the feature vector generator 224 in response to trigger condition 205 being satisfied. The average amount per transaction may be previously calculated using previous transaction events that are not included (or no longer included) in corresponding event streams 204 of FIG. 2A. The feature vector generator 224 can update the average amount per transaction with new event data accessed from the event streams 204 and stored in the joined event data structure 218 to generate an updated average amount per transaction. This updated information may be stored as part of the feature vector 226. It should be understood that the foregoing example is non-limiting and that similar approaches may be utilized to generate up-to-date values for any type of feature that may be provided as input to the machine-learning models 230.

The feature vector generator 224 can generate multiple feature vectors 226, for example, when a joined event data structure 218 includes event data for a child platform and a parent platform. To do so, the feature vector generator 224 can extract the event data corresponding to the child platform from the joined event data structure 218 to generate a first feature vector 226 corresponding to the child platform. The feature vector generator 224 can extract the event data corresponding to the parent platform from the joined event data structure 218 to generate a second feature vector 226 corresponding to the parent platform. Similar approaches may be performed when multiple joined event data structures 218 are provided to the feature system, each of which may correspond to a child platform or a parent platform individually in some implementations.

The configuration settings 214B may specify whether the generated feature vector(s) 226 are to be stored as part of a training and evaluation dataset 228 and/or provided as input to one or more machine-learning models 230. The training and evaluation dataset 228 can be a dataset with which the machine-learning models 230, or other artificial intelligence models, may be trained. Each feature vector 226 stored as part of the training and evaluation dataset 228 may be stored as input data for a training example.

In some implementations, ground truth data for the training examples in the training and evaluation dataset 228 can be updated via administrator input. In some implementations, ground truth data for training examples in the training and evaluation dataset 228 may be automatically populated based on a recorded outcome of the event that causes the trigger condition 205 to be satisfied. For example, if a transaction at a merchant/platform/system is determined to be fraudulent, the analytics server (or any other computing system that accesses the training and evaluation dataset 228) can update the ground truth data of the corresponding training example to indicate the transaction was fraudulent. Similar approaches can be performed for other attributes of the merchant/platform/system that artificial intelligence models can be trained/updated to predict.

The feature vector(s) 226 can be provided as input to one or more machine-learning models 230. The machine-learning models 230 can be any type of artificial intelligence model and may include but are not limited to neural networks, regression models, random forest models, decision tree models, or other models that may be trained/updated according to machine-learning techniques. In some implementations, the machine-learning models 230 can include fraud detection models. As shown, the machine-learning models 230 can generate one or more model outputs 232, which may include any predicted attribute of the merchant/system/platform, or event 210 or event stream 204 that caused the trigger condition 205 to be satisfied. The model outputs 232 can include, in an implementation where a machine learning model 230 includes a fraud detection model, a score indicating whether a transaction/event 210 is indicative of fraud.

In some implementations, the feature system 222 can provide multiple feature vectors 226 as input to different machine-learning models 230. For example, a first feature vector 226 generated for a parent platform/system can be provided as input to a first machine-learning model 230 trained to detect fraud at parent platforms, and a second feature vector 226 generated for a child platform/system can be provided as input to a second machine-learning model 230 trained to detect fraud at child platforms. Each machine-learning model 230 may include different input data formats (e.g., different features, different vector sizes/dimensions, and datatypes, etc.). The model outputs 232 can be provided to one or more computing systems, or used to flag actions, interactions, transactions, or other events 210 with certain attributes (e.g., an indication that a transaction is fraudulent, etc.).

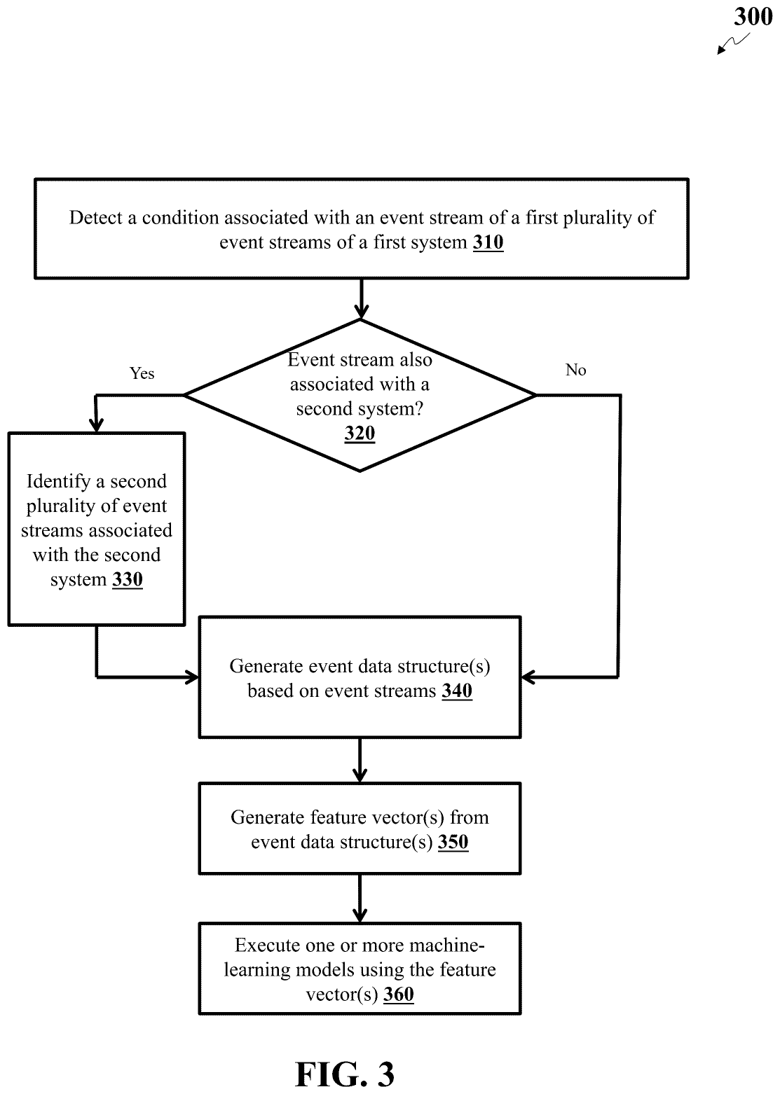

FIG. 3 illustrates a flow diagram of a process executed in an event joining and feature generation system, according to an embodiment. The method 300 includes steps 310-360. However, other embodiments may include additional or alternative execution steps, or may omit one or more steps altogether. The method 300 is described as being executed by a server, similar to the analytics server described in FIG. 1. However, one or more steps of method 300 may also be executed by any number of computing devices operating in the distributed computing system described in FIG. 1. For instance, one or more computing devices (e.g., user devices) may locally perform some or all of the steps described in FIG. 3.

Using the methods and systems described herein, such as the method 300, the analytics server may monitor event streams to detect whether trigger conditions are satisfied to generate one or more event data structures (e.g., a joined event data structure 218 of FIGS. 2A and 2B). The event data structures can be used in a feature generation process to generate one or more feature vectors. The feature vectors are provided as input to one or more machine-learning models, to generate predicted attributes/results for the event (or related events) retrieved from the event streams. One example machine-learning model may include a fraud-detection model, which can be executed to determine where a transaction is fraudulent in real-time or near real-time.

At step 310, the analytics server may detect a condition (e.g., a trigger condition 205) associated with an event stream (e.g., an event stream 204) associated with a first system (e.g., a first electronic payment system 120). To detect whether the condition has been satisfied, the analytics server can perform any of the functionality of the event joining system 208 described herein in connection with FIG. 2A. The “first system” may sometimes be referred to herein as a “first platform,” and can include any type computing system or device associated with a first entity that performs, processes, or is involved in certain electronic interactions, such as transactions or chargebacks. To detect the condition, the analytics server can monitor events published to one or more event streams, determine whether said events satisfies the condition. The condition may be specified in configuration settings (e.g., configuration settings 214A), as described herein. Each event stream can be associated with a respective event category and may be associated with one or more respective conditions.

In some implementations, the condition includes an indication of a security event associated with the first system, such as a security breach, password or sensitive data leak, or other security-based issue. The condition may be detected by monitoring events (e.g., events 210) published to event streams, or in response to a message/signal received from another computing system (e.g., an administrator computing device 140, an electronic payment system 120, etc.). The condition may correspond to an event stream identifying a particular entity (e.g., the first system, etc.). Detecting the condition may be performed in real-time or near real-time (e.g., as corresponding event streams are updated, etc.).

At step 320, the analytics server may determine whether the event stream is additionally associated with a second system (e.g., a second electronic payment system 120, corresponding to a parent/child entity relative to the first system, etc.). To do so, the analytics server can perform any of the functionality of the event joining system 208 of FIG. 2A. For example, the analytics server can access various configuration data (e.g., configuration settings 214A), data records, or metadata associated with the first system and/or the event stream to identify whether a second system is identified as having to a child or parent relationship with the first system.

If such a relationship is identified, and the condition indicates as such, the analytics server determine that the at least two feature vectors are to be generated in response to the condition. For example, the analytics server can determine that a secondary platform/merchant/system is a parent entity with respect to the first system, and access configuration settings associated with the respective condition to determine that multiple feature vectors are to be generated. In such implementations, a first feature vector can correspond to the first system, and a second feature vector can correspond to the second system. If at least two feature vectors are to be generated, the analytics server can continue to step 330. Otherwise, the analytics server can continue to step 340.

At step 330, the analytics server may identify a second plurality of event streams associated with the second system. The second plurality of event streams may include events published by the second system and not necessarily published/related to the first system. Such event streams may include events corresponding to time periods related to the condition and/or geographic locations related to the condition. The second event streams and/or events associated therewith can be identified, in some implementations, using corresponding keys identified in configuration settings associated with the condition and/or the first or second systems. The configuration settings may indicate which event streams of the second system are to be accessed for a given condition or given first system, in some implementations. Once the event streams are identified, the analytics server can continue to step 340.

At step 340, the analytics server may generate one or more event data structures (e.g., joined event data structure(s) 218) based on the event streams. The event data structure may be a single-row data structure with multiple columns. Each column in the data structure can include data extracted from events published to the event streams identified in step 310 and/or step 330. The analytics server can generate the event data structures using any of the techniques described herein, including those described in connection with FIG. 2A.

In some implementations, the analytics server can perform static or dynamic filtering of events of one or more identified event streams. Static filtering can include filtering events from inclusion in the event data structure according to predetermined time periods, transaction amounts, or any other attribute of said events or event streams. Specific filtering criteria can be specified in configuration settings associated with the condition and/or the first or second systems. Dynamic filtering may also be performed according to changing conditions of the event streams, for example, to filter instances where large volumes of transactions or events are published to one or more event streams, or if a condition is satisfied a large number of times in a relatively short time period. Criteria for dynamic filtering can also be specified in configuration settings accessible to the analytics server.

To generate an event data structure, the analytics server can retrieve events associated with one or more event streams corresponding to the first system. The event streams from which events are retrieved can be specified in the configuration settings and may be a function of the condition detected in step 310. In some implementations, if a second feature vector is to be generated for a parent system/platform, the analytics server can retrieve events from both a first set of event streams (corresponding to the first system) and a second set of event streams (corresponding to the second system). Events may be retrieved based on timestamps identified in said events published to the event streams, for example, to retrieve a predetermined number of recent events or events published or identified as occurring within a particular time period.

If multiple feature vectors are to be generated, the analytics server can store an indication of the system to which an event corresponds in the event data structure. In some implementations, a single event data structure can be generated to include events corresponding to the first system and the second system, with corresponding identifiers. In some implementations, multiple event data structures can be generated, such that a first event data structure includes event data corresponding to the first system, and a second event data structure includes event data corresponding to a second system.

At step 350, the analytics server may generate one or more feature vectors (e.g., feature vectors 226) from the one or more event data structures generated in step 340. To do so, the analytics server can perform any type of feature generation process, including the functionality of the feature system 222 of FIG. 2B. For example, the analytics server can convert the event data structure into one or more features, which are stored as part of a feature vector. The feature vector can correspond to an input layer of one or more machine-learning models (e.g., the machine-learning models 160, the machine-learning models 230, etc.). Converting the event data can include performing aggregation algorithms, normalization algorithms, or other pre-processing algorithms to convert the event data into a numerical format that is compatible with the machine-learning model(s).

In some implementations, the analytics server can generate the feature vectors described herein by accessing archived events and/or feature data. For example, the analytics server can retrieve a set of historic events corresponding to the first system and/or the second system from a data archive (e.g., the archived data 206, etc.). Said archived events or features may be previously generated features or events that are no longer stored in an event stream, but still relevant to current machine-learning processing. The analytics server can access the historic event data or historic feature data and process the historic event data or historic feature data according to the techniques described herein to generate one or more feature vectors.

In some implementations, the analytics server can convert the event data structure into the at least two feature vectors responsive to determining that the at least two feature vectors are to be generated. For example, if the event data structure includes indications of a parent/child relationship between a first system and a second system, the analytics server can generate respective feature vectors for each of the first system and the second system. In some implementations, the first feature vector can be generated based on the event data corresponding to the first system, and the second feature vector can be generated based on the event data corresponding to the second system. Each of the generated feature vectors can have different dimensionalities and features and may be provided as input to different machine-learning models, in some implementations.

At step 360, the analytics server may execute one or more machine-learning models using the feature vector(s). Executing the machine-learning models can include providing the one or more feature vectors generated at step 350 as input to the one or more machine-learning models. As described herein, each machine-learning model can be trained/updated to generate a predicted attribute or characteristic of the system/platform or events to which the input feature vector corresponds. In one example, the machine-learning models can include fraud detection models, which output a likelihood that a given event (e.g., a transaction, a chargeback, etc.) represents a fraudulent transaction.

In some implementations, the analytics server can execute a first machine-learning model using a first feature vector of the first system as input to generate a first likelihood of fraud for the first system. In some implementations, the analytics server can execute a second machine-learning model using the second feature vector of the second system as input to generate a second likelihood of fraud for the second system. Each of these outputs can be associated with the corresponding condition, event stream, or event that caused generation of the first and second feature vectors.

Upon at least one machine-learning model generating an output that indicates an event or system is related to or involved in a fraudulent action (e.g., a fraudulent transaction), the analytics server can generate a flag for the event or system that includes the indication. The flag can cause one or more fraud management systems to activate according to the predicted fraudulent action. In some implementations, the analytics server can restrict the processing of an electronic payment corresponding to the event or system that is identified as engaging in a potentially fraudulent activity.

### Non-Limiting Example:

In one non-limiting example of the foregoing techniques, a contractor, such as a driver for a transportation service, can initiate a transaction by confirming a request to pick up a customer. Said transaction can be published as at least one event in an event stream (e.g., an event stream 204). Said event can cause a condition (e.g., trigger condition 205) to be satisfied, initiating a process to generate feature vectors (e.g., feature vectors 226) for machine-learning models (e.g., machine-learning models 230) to detect an instance of fraud.

In this example, the transportation service is a parent entity with respect to the driver for the transportation service (e.g., a child entity), and therefore event data (e.g., events 210) corresponding to both the driver and the and transportation service can be accessed and used to generate one or more joint event data structures (e.g., joined event data structure(s) 218). Such events may include but are not limited to similar transactions previously occurring in a similar location and/or within a recent time period, other transactions identifying the particular driver, or other transaction information associated with a given payment method, among others. The joined event data structure(s) can be used to generate a feature vector by performing various processing operations on the event data retrieved for the driver and the transportation service.

Furthering this non-limiting example, one feature vector can be generated for the driver and another feature vector can be generated for the transportation service. Each feature vector can be provide as input to one or more of the machine-learning models to generate respective indications of fraud likelihood for the driver and the transportation service. Said indications may be utilized for further downstream payment processing operations, for example, to block or restrict performance of the transaction or to initiate security risk investigations at one or more computing systems of the transportation service.

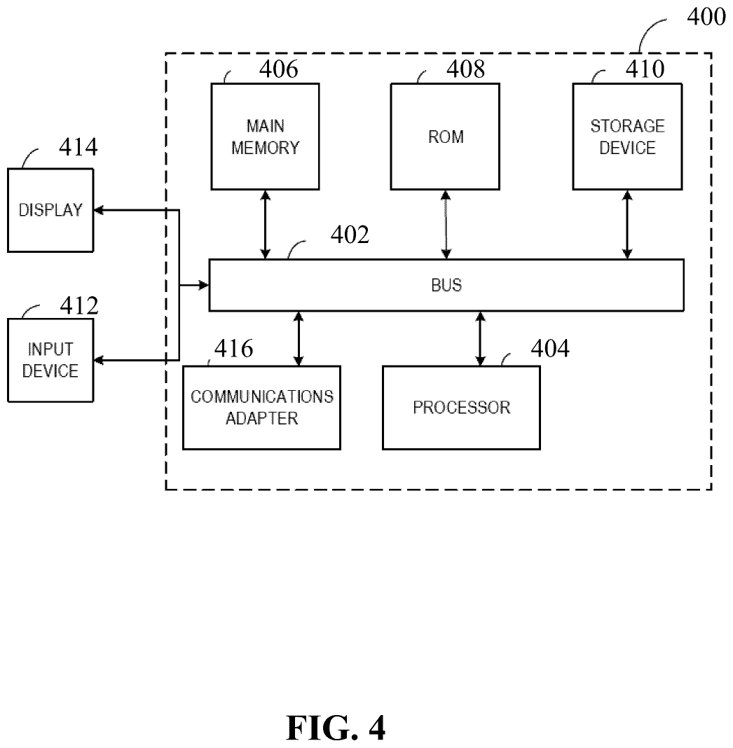

FIG. 4 is a component diagram of an example computing system suitable for use in the various implementations described herein, according to an example implementation. One or more steps of the methods and processes discussed herein can be performed by the computing system depicted in FIG. 4.

The computing system 400 includes a bus 402 or other communication component for communicating information and a processor 404 coupled to the bus 402 for processing information. The computing system 400 also includes main memory 406, such as a RAM or other dynamic storage device, coupled to the bus 402 for storing information, and instructions to be executed by the processor 404. Main memory 406 can also be used for storing position information, temporary variables, or other intermediate information during the execution of instructions by the processor 404. The computing system 400 may further include a ROM 408 or other static storage device coupled to the bus 402 for storing static information and instructions for the processor 404. A storage device 410, such as a solid-state device, magnetic disk, or optical disk, is coupled to the bus 402 for persistently storing information and instructions.

The computing system 400 may be coupled via the bus 402 to a display 414, such as a liquid crystal display, or active-matrix display, for displaying information to a user. An input device 412, such as a keyboard including alphanumeric and other keys, may be coupled to the bus 402 for communicating information, and command selections to the processor 404. In another implementation, the input device 412 has a touch screen display. The input device 412 can include any type of biometric sensor, or a cursor control, such as a mouse, a trackball, or cursor direction keys, for communicating direction information and command selections to the processor 404 and for controlling cursor movement on the display 414.

In some implementations, the computing system 400 may include a communications adapter 416, such as a networking adapter. Communications adapter 416 may be coupled to bus 402 and may be configured to enable communications with a computing or communications network or other computing systems. In various illustrative implementations, any type of networking configuration may be achieved using communications adapter 416, such as wired (e.g., via Ethernet), wireless (e.g., via Wi-Fi, Bluetooth), satellite (e.g., via GPS) pre-configured, ad-hoc, LAN, WAN, and the like.

According to various implementations, the processes of the illustrative implementations that are described herein can be achieved by the computing system 400 in response to the processor 404 executing an implementation of instructions contained in main memory 406. Such instructions can be read into main memory 406 from another computer-readable medium, such as the storage device 410. Execution of the implementation of instructions contained in main memory 406 causes the computing system 400 to perform the illustrative processes described herein. One or more processors in a multi-processing implementation may also be employed to execute the instructions contained in main memory 406. In alternative implementations, hard-wired circuitry may be used in place of or in combination with software instructions to implement illustrative implementations. Thus, implementations are not limited to any specific combination of hardware circuitry and software.

The implementations described herein have been described with reference to drawings. The drawings illustrate certain details of specific implementations that implement the systems, methods, and programs described herein. However, describing the implementations with drawings should not be construed as imposing on the disclosure any limitations that may be present in the drawings.

As used herein, the term “circuit” may include hardware structured to execute the functions described herein. In some implementations, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some implementations, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating the achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some implementations, the one or more processors may be embodied in various ways. The one or more processors may be constructed in a manner sufficient to perform at least the operations described herein. In some implementations, the one or more processors may be shared by multiple circuits (e.g., circuit A and circuit B may comprise or otherwise share the same processor, which, in some example implementations, may execute instructions stored, or otherwise accessed, via different areas of memory). Alternatively or additionally, the one or more processors may be structured to perform or otherwise execute certain operations independent of one or more co-processors.

In other example implementations, two or more processors may be coupled via a bus to enable independent, parallel, pipelined, or multi-threaded instruction execution. Each processor may be implemented as one or more general-purpose processors, ASICs, FPGAs, GPUs, TPUs, digital signal processors (DSPs), or other suitable electronic data processing components structured to execute instructions provided by memory. The one or more processors may take the form of a single core processor, multi-core processor (e.g., a dual core processor, triple core processor, or quad core processor), microprocessor, etc. In some implementations, the one or more processors may be external to the apparatus, for example, the one or more processors may be a remote processor (e.g., a cloud-based processor). Alternatively or additionally, the one or more processors may be internal or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the implementations might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile or non-volatile memories), etc. In some implementations, the non-volatile media may take the form of ROM, flash memory (e.g., flash memory such as NAND, 3D NAND, NOR, 3D NOR), EEPROM, MRAM, magnetic storage, hard discs, optical discs, etc. In other implementations, the volatile storage media may take the form of RAM, TRAM, ZRAM, etc. Combinations of the above are also included within the scope of machine-readable media. In this regard, machine-executable instructions comprise, for example, instructions and data which cause a general-purpose computer, special-purpose computer, or special-purpose processing machine to perform a certain function or group of functions. Each respective memory device may be operable to maintain or otherwise store information relating to the operations performed by one or more associated circuits, including processor instructions and related data (e.g., database components, object code components, script components), in accordance with the example implementations described herein.

It should also be noted that the term “input devices,” as described herein, may include any type of input device, including, but not limited to, a keyboard, a keypad, a mouse, a joystick, or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative implementations. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence has any limiting effect on the scope of any claim elements.

The foregoing description of implementations has been presented for purposes of illustration and description. It is not intended to be exhaustive or to limit the disclosure to the precise form disclosed, and modifications and variations are possible in light of the above teachings or may be acquired from this disclosure. The implementations were chosen and described in order to explain the principals of the disclosure and its practical application to enable one skilled in the art to utilize the various implementations and with various modifications as are suited to the particular use contemplated. Other substitutions, modifications, changes, and omissions may be made in the design, operating conditions, and implementation of the implementations without departing from the scope of the present disclosure as expressed in the appended claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What we claim is:

1. A system, comprising:
one or more processors coupled to non-transitory memory, the one or more processors configured to:
detect a condition associated with an event stream of a first plurality of event streams associated with a first system;
determine that the event stream is associated with a second system;
identify a second plurality of event streams associated with the second system;
generate, based on the condition, an event data structure comprising a first set of events identified from the first plurality of event streams and a second set of events identified from the second plurality of event streams;
convert the event data structure into at least two feature vectors corresponding to the first system and the second system for one or more machine-learning models; and
execute the one or more machine-learning models using the at least two feature vectors as input and outputting a likelihood of fraud for the first system or the second system.

2. The system of claim 1, wherein the one or more processors are further configured to:
retrieve the first set of events of the first plurality of event streams based on respective timestamps identified in each of the first plurality of event streams.

3. The system of claim 1, wherein the one or more processors are further configured to:
generate the first set of events based on a filtering process applied to data retrieved from the first plurality of event streams, the filtering process performed based on a number of events stored in association with the first plurality of event streams.

4. The system of claim 1, wherein the one or more processors are further configured to:
determine, based on the condition associated with the event stream, that the at least two feature vectors are to be generated; and
convert the event data structure into the at least two feature vectors responsive to determining that the at least two feature vectors are to be generated.

5. The system of claim 1, wherein the event data structure comprises a plurality of columns each corresponding to a respective event stream of the first plurality of event streams.

6. The system of claim 1, wherein the condition comprises an indication of a security event associated with the first system.

7. The system of claim 1, wherein the one or more processors are further configured to:
generate a flag for the first system based on an output of the one or more machine-learning models, the flag corresponding to the event stream of the first plurality of event streams.

8. The system of claim 1, wherein the one or more processors are further configured to:
execute a first machine-learning model using a first feature vector as input to generate a first likelihood of fraud for the first system; and
execute a second machine-learning model using a second feature vector as input to generate a second likelihood of fraud for the second system.

9. The system of claim 1, wherein the one or more processors are further configured to:
retrieve a set of historic events corresponding to the first system; and
convert the event data structure and the set of historic events into the at least two feature vectors.

10. The system of claim 1, wherein each of the plurality of event streams is associated with a respective event category.

11. A method, comprising:
detecting, by one or more processors coupled to non-transitory memory, a condition associated with an event stream of a first plurality of event streams associated with a first system;
determining, by the one or more processors, that the event stream is associated with a second system;
identifying, by the one or more processors, a second plurality of event streams associated with the second system;
generating, by the one or more processors, based on the condition, an event data structure comprising a first set of events identified from the first plurality of event streams and a second set of events identified from the second plurality of event streams;
converting, by the one or more processors, the event data structure into at least two feature vectors corresponding to the first system and the second system for one or more machine-learning models; and
executing, by the one or more processors, the one or more machine-learning models using the at least two feature vectors as input and outputting a likelihood of fraud for the first system or the second system.

12. The method of claim 11, further comprising:
retrieving, by the one or more processors, the first set of events of the first plurality of event streams based on respective timestamps identified in each of the first plurality of event streams.

13. The method of claim 11, further comprising:
generating, by the one or more processors, the first set of events based on a filtering process applied to data retrieved from the first plurality of event streams, the filtering process performed based on a number of events stored in association with the first plurality of event streams.

14. The method of claim 11, further comprising:
determining, by the one or more processors, based on the condition associated with the event stream, that the at least two feature vectors are to be generated; and
converting, by the one or more processors, the event data structure into the at least two feature vectors responsive to determining that the at least two feature vectors are to be generated.

15. The method of claim 11, wherein the condition comprises an indication of a security event associated with the first system.

16. The method of claim 11, further comprising:
generating, by the one or more processors, a flag for the first system based on an output of the one or more machine-learning models, the flag corresponding to the event stream of the first plurality of event streams.

17. The method of claim 11, further comprising:
executing, by the one or more processors, a first machine-learning model using a first feature vector as input to generate a first likelihood of fraud for the first system; and
executing, by the one or more processors, a second machine-learning model using a second feature vector as input to generate a second likelihood of fraud for the second system.

18. The method of claim 11, further comprising:
retrieving, by the one or more processors, a set of historic events corresponding to the first system; and
converting, by the one or more processors, the event data structure and the set of historic events into the at least two feature vectors.

19. The method of claim 11, wherein each of the plurality of event streams is associated with a respective event category.

20. A non-transitory computer readable medium with instructions embodied thereon that, when executed by one or more processors, cause the one or more processors to perform operations comprising:
detecting a condition associated with an event stream of a first plurality of event streams associated with a first system;
determining that the event stream is associated with a second system;
identifying a second plurality of event streams associated with the second system;
generating, based on the condition, an event data structure comprising a first set of events identified from the first plurality of event streams and a second set of events identified from the second plurality of event streams;
converting the event data structure into at least two feature vectors corresponding to the first system and the second system for one or more machine-learning models; and
executing the one or more machine-learning models using the at least two feature vectors as input and outputting a likelihood of fraud for the first system or the second system.
